(19) United States
(12) Patent Application Publication
(10) Pub. No.: US 2011/0142244 A1
(43) Pub. Date: Jun. 16, 2011

(54) DELAY AMOUNT DETERMINATION DEVICE, SOUND IMAGE LOCALIZATION DEVICE, DELAY AMOUNT DETERMINATION METHOD AND DELAY AMOUNT DETERMINATION PROCESSING PROGRAM

(75) Inventors: Kensaku Obata, Kanagawa-ken (JP); Yoshiki Ohta, Kanagawa-ken (JP)

(73) Assignee: PIONEER CORPORATION, Kanagawa-ken (JP)

(21) Appl. No.: 13/003,669

(22) PCT Filed: Jul. 11, 2008
(86) PCT No.: PCT/JP2008/062598

§ 371 Date: Feb. 11, 2011

(51) Int. Cl. H04R 5/00

(52) U.S. Cl. 381/17

(57) ABSTRACT

A delay amount determination device, sound image localization device, delay amount determination method, and delay amount determination processing program capable of efficiently determining a parameter using fewer test sounds are provided. If the localization direction of the sound image when the test sound is outputted from left and right speakers is specified by the user through an input unit, an operation unit finds the localization angle corresponding to the localization direction. The operation unit, if finding localization angles with two different delay values, compares the difference of the two localization angles with a threshold value. The operation unit, if judging that the difference is larger than the threshold value, changes one of the delay values, finds the localization angle corresponding to the changed delay value, and further compares the difference of the two localization angles with the threshold value.

### BACKGROUND OF THE INVENTION

1. Field of the Invention

The present invention relates to a delay amount determination device, sound image localization device, delay amount determination method and delay amount determination processing program for setting parameters related to the position of a sound image in a surround system based on subjective experimentation by a listener.

2. Description of the Related Art

In order to use a sound system such as a 5.1ch surround system, it is necessary to place speakers for surround sound behind the listener, however, often in a typical home there is not enough space to place surround speakers, so a front surround system has been proposed wherein a surround effect is achieved by using only front speakers.

For example, the inventors of the present invention have proposed a surround playback system (non-patent literature 1) that outputs an inputted surround signal to a corresponding speaker of a left and right speaker, and together with delaying this surround signal by a specified delay amount for each frequency band, attenuates the surround signal and outputs that signal to the other speaker.

With this surround playback system, basically only the phase of each band is controlled, so there is little degradation of the sound quality, and because information that relies on the characteristics of the listener, such as a head-related transfer function, is not used, there is little individual difference of the effect.

Incidentally, in this kind of surround system, in order to set parameters such that a surround effect can be obtained that is suitable to the user and listening environment, the user must perform experimentation and measurement of the listening environment. However, such work must be performed by outputting a test sound for each frequency band and for each parameter to be set (the delay amount for each band in the case of the invention in non-patent literature 1), so a considerable load is placed on the user.

On the other hand, in order to perform this kind of work more easily and efficiently, the invention disclosed in patent literature 1 moves the location of an audio signal along a specified movement track, and the user sets the location that is determined to be the most suitable locations as the location for setting that audio signal.

However, in the invention disclosed in patent literature 1, while moving the sound location, the user must constantly be aware of that location, placing a large burden on the user, and therefore the effect is limited.

Non-patent literature 1: Kensaku Obata, et al., “The Surround Sound System Consisting of Two Front Loudspeakers”, Virtual Reality Society of Japan, 12th Annual Conference, September 2007
Patent literature 1: Japanese patent application No. 2005-101738

### SUMMARY OF THE INVENTION

Considering the above situation, the object of the present invention is to provide a delay amount determination device, a sound image localization device, a delay amount determination method and delay amount determination processing program capable of effectively setting parameters by reducing the amount of test sounds that the listener must listen to.

In order to solve the problems above, the delay amount determination device according to one aspect of the present invention comprises: a test sound signal output unit that outputs a test sound signal; a delay unit that delays the test sound signal according to the set delay amount; an input unit for inputting the localization direction of the sound image felt by the listener when a test sound that corresponds to the test sound signal is outputted from one speaker, and when a test sound that corresponds to the test sound signal that was delayed by the delay unit is outputted from another speaker; a comparison unit that compares the difference between one localization angle and another localization angle with a threshold value, wherein the localization angles correspond with localization directions that were inputted using the input unit when the test sound signal is delayed by two different delay amounts; a control unit that changes one of the two delay amounts while determining whether the difference is greater than the threshold value, and causes the comparison unit to perform the comparison using the one localization angle and the other localization angle when the test sound signal is delayed by the changed delay amount; and a selection unit that selects one delay amount within a range from one of the two delay amounts to the other delay amount based on a predetermined condition when the difference is determined to be less than the threshold value.

In another aspect of the present invention, a sound image localization device comprises: the aforementioned delay amount determination device; a setting unit that sets the delay amount selected by the selection unit as the delay amount to be used by the delay unit; one output unit that outputs the inputted sound signal to one of the speakers; and another output unit that outputs the sound signal that was delayed by the delay unit to the other speaker; wherein the delay unit delays the sound signal.

Moreover, in another aspect of the present invention, a sound image localization device comprises: the aforementioned delay amount determination device; a setting unit that sets the delay amount selected by the selection unit and the delay amount calculated by the calculation units as delay amounts to be used by the delay unit for the corresponding frequencies; one output unit that outputs the inputted sound signal to one of the speakers; and another output unit that outputs the sound signal that was delayed by the delay unit to the other speaker; wherein the delay unit delays the sound signal for each frequency.

Furthermore, in another aspect of the present invention, a delay amount determination method comprises steps of: outputting a test sound signal; delaying the test sound signal according to the set delay amount; comparing the difference between one localization angle and another localization angle with a threshold value, wherein the localization angles correspond with localization directions that were inputted using an input unit for inputting the localization direction of the sound image felt by the listener when a test sound that corresponds to the test sound signal is outputted from one speaker, and a test sound that corresponds to the test sound signal that was delayed is output from another speaker, when the test sound signal is delayed by two different delay amounts; changing one of the two delay amounts while determining whether the difference is greater than the threshold value, and performing comparison using the one localization angle and the other localization angle when the test sound signal is delayed by the changed delay amount; and selecting one delay amount within a range from one of the two delay amounts to the other delay amount based on a predetermined condition when the difference is determined to be less than the threshold value.

In yet a further aspect of the present invention, a delay amount determination processing program causes a computer to function as: a test sound signal output unit that outputs a test sound signal; a delay unit that delays the test sound signal according to the set delay amount; an input unit for inputting the localization direction of the sound image felt by the listener when a test sound that corresponds to the test sound signal is outputted from one speaker, and a test sound that corresponds to the test sound signal that was delayed by the delay unit is outputted from another speaker; a comparison unit that compares the difference between one localization angle and another localization angle with a threshold value, wherein the localization angles correspond with localization directions that were inputted using the input unit when the test sound signal is delayed by two different delay amounts; a control unit that changes one of the two delay amounts while determining whether the difference is greater than the threshold value, and causes the comparison unit to perform comparison using the one localization angle and the other localization angle when the test sound signal is delayed by the changed delay amount; and a selection unit that selects one delay amount within a range from one of the two delay amounts to the other delay amount based on a predetermined condition when the difference is determined to be less than the threshold value.

### BRIEF DESCRIPTION OF THE DRAWINGS

FIG. 1 is a block diagram illustrating an example of the construction of a delay value setting device 10 of an embodiment of the present invention.

FIG. 2 is an example of a graph illustrating the relationship between the delay value and localization angle that are obtained in a subjective experiment.

FIG. 3 is an example of a graph illustrating the relationship between the delay value and localization angle in order to explain a method for calculating the optimum delay value.

FIGS. 4A and 4B are examples of graphs illustrating the results of a subjective experiment when the frequency of the test sound is 500 Hz, where FIG. 4A is a graph for a tester A, and FIG. 4B is a graph for a tester B.

FIGS. 5A and 5B are examples of graphs illustrating the results of a subjective experiment when the frequency of the test sound is 250 Hz, where FIG. 5A is a graph for a tester A, and FIG. 5B is a graph for a tester B.

FIGS. 6A and 6B are examples of graphs illustrating the results of a subjective experiment when the frequency of the test sound is 125 Hz, where FIG. 6A is a graph for a tester A, and FIG. 6B is a graph for a tester B.

FIG. 7 is an example of a graph illustrating the relationship between the frequency and optimum delay value obtained in a subjective experiment.

FIG. 8 is a flowchart illustrating the processing contents of the optimum delay value setting process of the delay value setting device 10 of an embodiment of the present invention.

FIG. 9 is a flowchart illustrating the processing contents of a localization experimentation process by the delay value setting device 10 of an embodiment of the present invention.

FIGS. 10A and 10B are diagrams illustrating an example of a display on a GUI screen 300 for a localization response.

FIG. 11 is a block diagram illustrating an example of construction of an AV amp 50 of an embodiment of the present invention.

### EXPLANATION FOR SYMBOL

10 Delay Value Setting Device
11 CALCULATION UNIT
12 MEMORY UNIT
13 TEST SIGNAL GENERATION UNIT
14 DELAY UNIT
15 GUI DISPLAY UNIT
16 INPUT UNIT
50 AV AMP
51 MICROCOMPUTER
52 MEMORY
53 DECODER
54 TEST SIGNAL GENERATION CIRCUIT
55, 56 SWITCH
57, 60 ATTENUATOR
58, 61 ALL-PASS FILTER
59, 62 ADDER
63 DISPLAY
64 MOUSE
100 USER
200 SOUND IMAGE
LSP LEFT-SIDE SPEAKER
RSP RIGHT-SIDE SPEAKER
SW SUBWOOFER

### DESCRIPTION OF THE PREFERRED EMBODIMENT

In the following, the preferred embodiment of the present invention is explained in detail with reference to the accompanying drawings. The embodiment explained below is an embodiment wherein the present invention is applied to a delay value setting device.

### [1. Summary of a Surround Playback System]

First, a summary of the surround playback system in which the delay value setting device 10 of this embodiment is installed is explained.

As disclosed in non-patent literature 1 above, the surround device outputs a surround signal (example of an audio signal) as is to one of the speakers, and after using an all-pass filter (an example of a delay unit) to delay this surround signal by a set delay value for each frequency band, attenuates the signal and outputs that signal to the other speaker.

More specifically, this surround playback system is constructed such that a surround signal for the left side that was inputted from an external source is outputted as is to the front left speaker, and the surround signal for the right side is delayed by an all-pass filter, after which it is attenuated and outputted to the front right speaker. In addition, for the surround signal for the right side, by simply changing the left and right, the construction is the same as in the case of the signal for the left side.

Here, the delay value that is used for the all-pass filter is an example of a delay value, with the unit being radians. In this surround playback system, the delay value for each frequency band is a parameter for determining the localization angle of the sound image of the surround sound.

Therefore, the delay value setting device 10 sets the optimum delay value for the listening environment (example of a listening environment) of the user (example of a listener) using this surround playback system according to a subjective test by the user.

### [2. Construction of the Delay Value Setting Device]

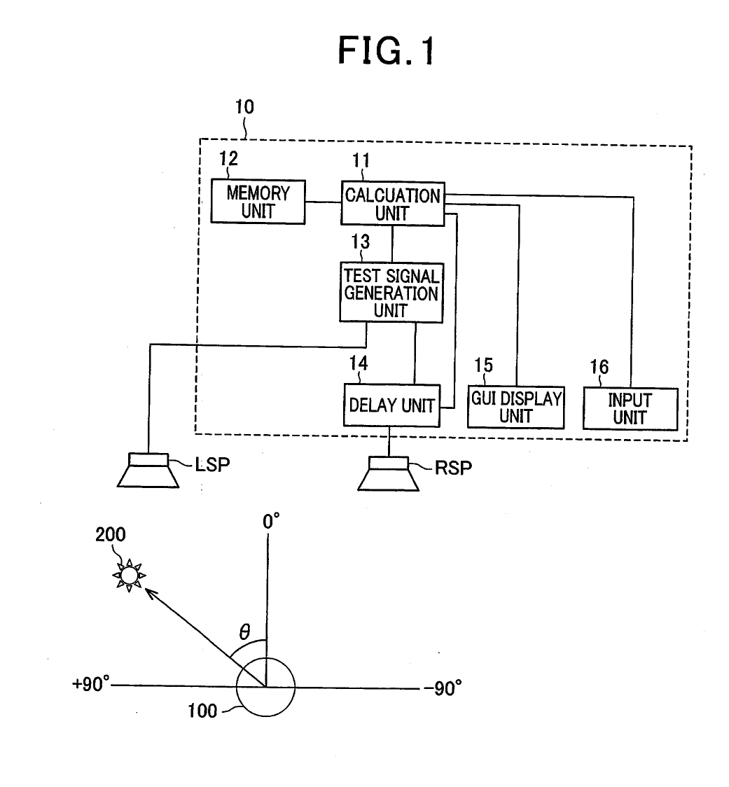

Next, the construction of the delay value setting device 10 of this embodiment is explained using FIG. 1.

FIG. 1 is a block diagram illustrating an example of the construction of the delay value setting device 10 of this embodiment.

The delay value setting device 10 forms part of the surround playback system above, however, except for the delay value setting device 10, an explanation of the detailed construction of the surround playback system is omitted. In addition, in the following, only an explanation of the construction for setting the delay value for processing the surround signal on the left side in the surround playback system above is given, however, the construction for setting the delay value for processing the surround signal on the right side is the same.

As illustrated in FIG. 1, the delay value setting device 10 comprises: a calculation unit 11 as an example of a comparison unit, a control unit, a selection unit and a calculation unit, a memory unit 12, a test signal generation unit 13 as an example of a test sound signal output unit, a delay unit 14 as an example of a delay unit, a GUI display unit 15, and an input unit 16 as an example of an input unit.

The calculation unit 11 comprises a CPU (Central Processing Unit), ROM (Read Only Memory) and RAM (Random Access Memory), and controls the overall delay value setting unit 10 by reading and executing various programs that are stored in the memory unit 12, as well as functions as a comparison unit, control unit, selection unit and calculation unit.

The memory unit 12 is a non-volatile memory unit such as flash memory, and stores various programs. In addition, together with storing delay values for each set frequency band, the memory unit 12 stores in advance the delay value that is presumed to be the optimum vale for a certain frequency band. Programs can be supplied from a memory medium via a drive device that is not illustrated in the figure, can be acquired from a server device via a network, and can be stored in memory beforehand at the time of shipment of the delay value setting device 10.

The test signal generation unit 13 supplies a test signal (example of a test audio signal) having a frequency specified by the calculation unit 11 to the left-side speaker LSP and delay unit 14.

The delay unit 14 delays the test signal that was supplied from the test signal generation unit 13 by a phase amount indicated by a delay value specified by the calculation 11, and supplies the delayed test signal to the right-side speaker RSP.

The GUI display unit 15 comprises a liquid-crystal display, for example, and displays text and images based on control from the calculation unit 11.

The input unit 16 comprises a pointing device such as a mouse or touch panel, receives an operation instruction from a user and supplies that instruction to the calculation unit 11 as an instruction signal.

Here, the GUI display unit 15 and input unit 16 provide a graphic user interface for the user to subjectively input the location of a sound image based on the test sound that is outputted from the speakers LSP and RSP.

The reference number 100 represents the head of the user, and the reference number 200 represents the sound image.

### [3. Optimum Delay Value Determination Method]

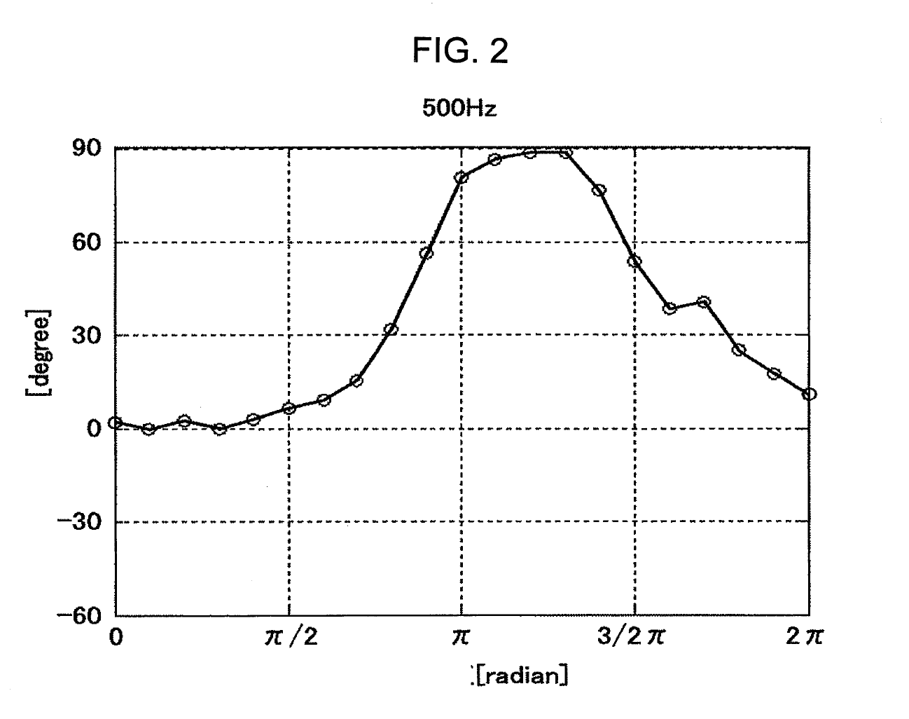

Next, the method used by the delay value setting device 10 of this embodiment for determining the optimum delay value to store in the memory unit 12 is explained using FIG. 2 to FIG. 7.

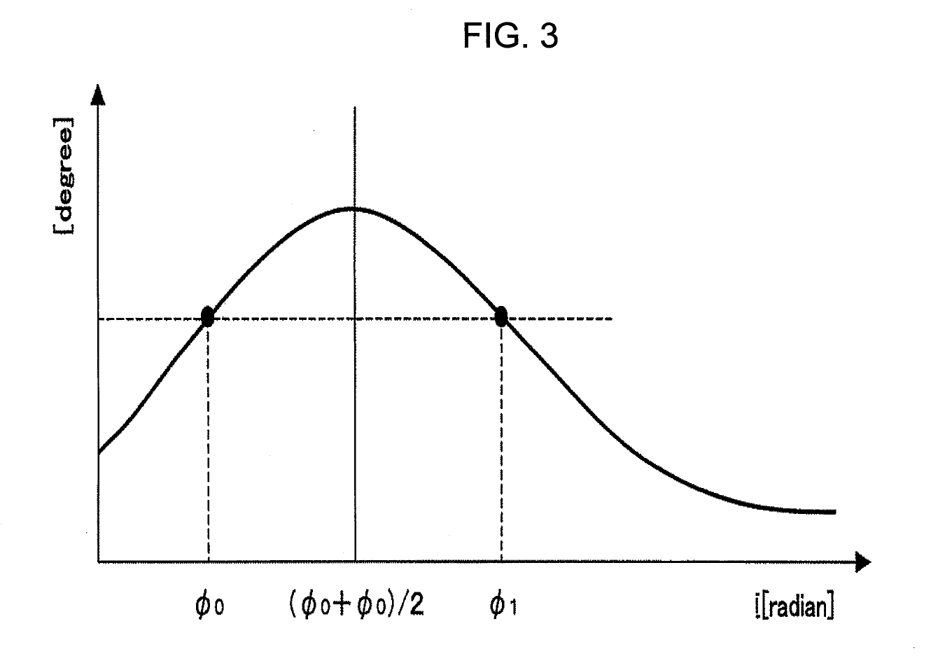

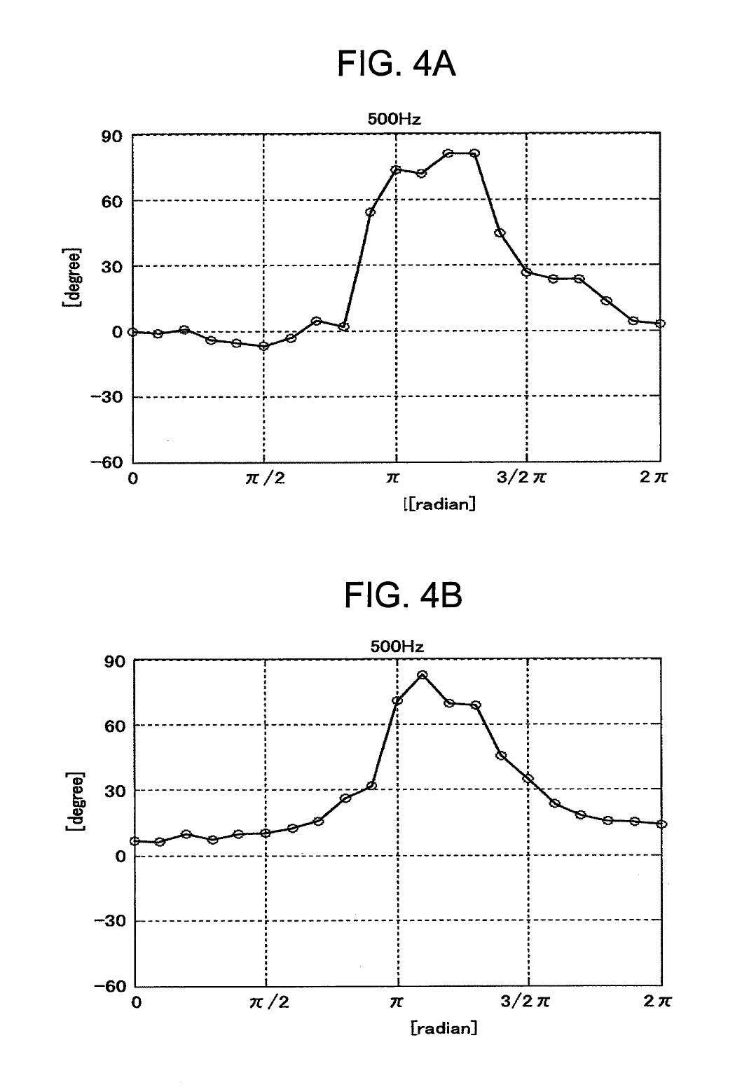

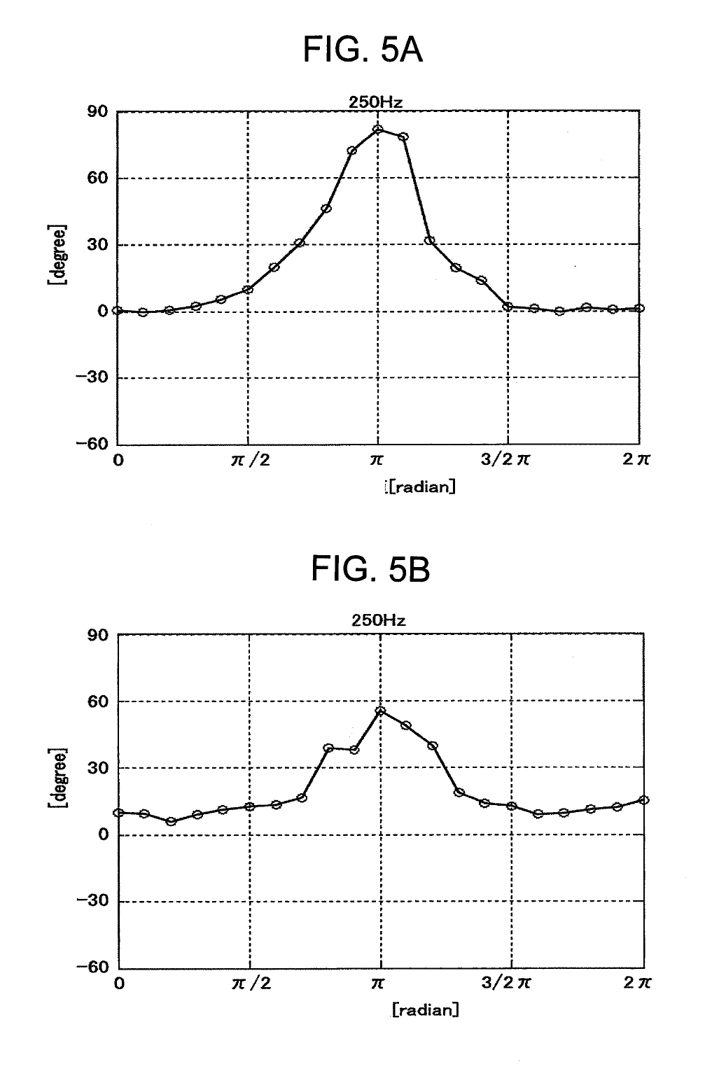

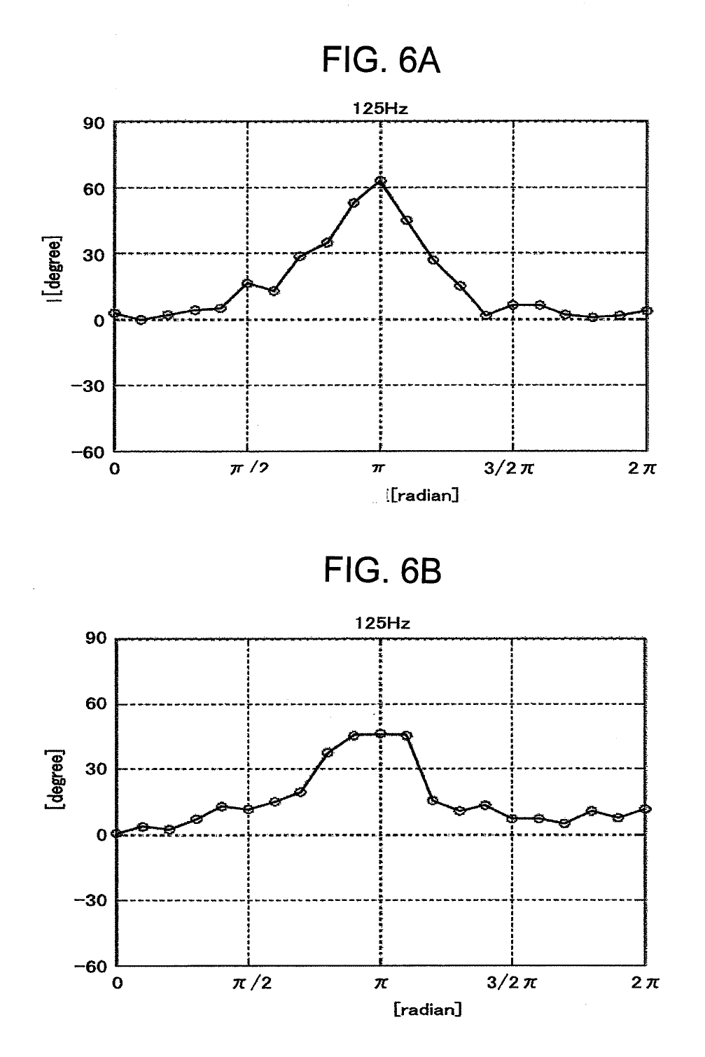

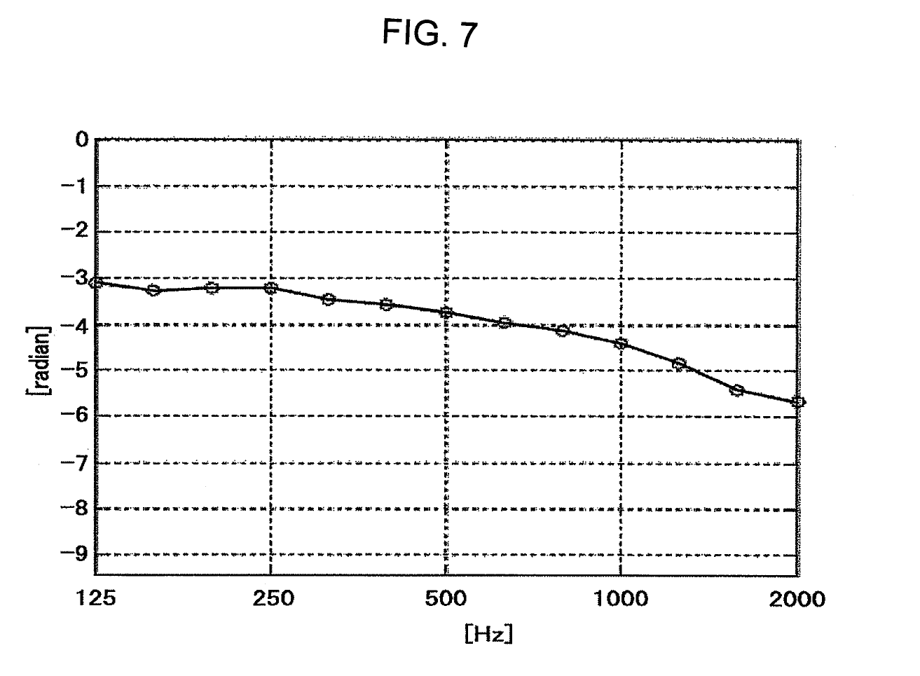

FIG. 2 is an example of a graph illustrating the relationship between the delay values and localization angles obtained in a subjective test. FIG. 3 is an example of a graph illustrating the relationship between the delay values and localization angles for explaining the method for calculating the optimum delay value. FIGS. 4A and 4B are examples of graphs illustrating the results of a subjective test when the frequency of the test sound is 500 Hz, where FIG. 4A is a graph for a tester A, and FIG. 4B is a graph for a tester B. FIGS. 5A and 5B are examples of graphs illustrating the results of a subjective test when the frequency of the test sound is 250 Hz, where FIG. 5A is a graph for a tester A, and FIG. 5B is a graph for a tester B. FIGS. 6A and 6B are examples of graphs illustrating the results of a subjective test when the frequency of the test sound is 125 Hz, where FIG. 6A is a graph for a tester A, and FIG. 6B is a graph for a tester B. FIG. 7 is an example of a graph illustrating the relationship between the frequencies and optimum delay values that were obtained in a subjective test.

In this embodiment, the optimum delay values are determined for two frequency bands, after which the optimum delay values for other frequency bands are determined based on those two optimum delay values.

### [3.1 Method for Determining Optimum Delay Values for Two Frequencies]

FIG. 2 is a graph illustrating the results obtained in a subjective test performed by the inventors of the present invention for a test sound having a frequency of 500 Hz, and indicates the localization angles of the sound image of the test sound felt by the testers at every 0.1π interval from 0 to 2π.

The localization angle in this case is °0 in the direction in front of the user and increases as the direction of the sound image that the user feels expands to the left side. The localization angle is +90° when the sound image is directly to the left of the user, and the localization angle is −90° when the sound image is directly to the right of the user. This is the localization angle when the test sound for the right speaker RSP is delayed, and when the test sound for the left speaker LSP is delayed, the plus and minus are reversed.

As illustrated in FIG. 2, in this subjective test, the localization angle becomes a maximum when the delay value is near 1.2π radians to 1.3π radians, and that delay value is the optimum delay value.

Moreover, the localization angle for other delay values shifts a little, and with the angle near 1.2π radians to 1.3π radians for the optimum delay value being the axis of symmetry, this is nearly an axisymmetrical relationship.

With the premise that the localization angles for each delay value are axisymmetric with the optimum delay value as the axis of symmetry in this way, it is presumed that the delay value where the localization angle will become a maximum is located between the delay angles φ0 and φ1. In doing so, when φ0=φ01, the average of φ0 and φ1 is (φ0+φ1)/2, and this is taken to be the optimum delay value.

Therefore, in this embodiment, the localization angle when the delay value is φ0, and the localization angle when the delay value is φ1 are found through subjective testing. In addition, subjective testing is performed while changing φ0 and φ1 so that their respective values become close to each other until the difference between the two localization angles becomes a specified threshold value or less.

For example, the localization angle θ0 that is obtained when the delay value is taken to be φ0, and the localization angle θ1 that is obtained when the delay value is taken to be φ1 are compared, and when θ0 is larger, the optimum delay value is considered to be less than (φ0+φ1)/2. In other words, the optimum delay value is considered to be a value closer to φ0 than to φ1.

For this reason, in this embodiment, the delay value for which the localization angle is smaller (φ1 in the example above) is changed to (φ0+φ1)/2, and the subjective testing is performed again just for the delay value that was changed.

In this way, when the difference between the two localization values becomes equal to or less than the threshold value, the average value of φ0 and φ1 is set as the optimum delay value. In doing so, it is possible to reduce the number of delay values that are to be the object of subjective testing.

The smaller the threshold value is made, the more possible it is to increase the precision of the optimum delay value, however, the amount of calculation is also increased, so preferably the threshold value is set to a suitable value according to the target system. The user can also set this threshold value.

It is not absolutely necessary to select the average value of φ0 and φ1 as the optimum delay value, for example, when the tendency of how the localization angle decreases from the optimum delay value is known in advance, a suitable delay value that corresponds to that tendency can be selected within the range from φ0 to φ1.

Moreover, the delay value for which subjective testing is performed again does not necessarily need to be limited to (φ0+φ1)/2 after changing the value. For example, the delay value having a larger localization value can be changed to a value that moves away from the other delay value.

In order to find the optimum delay value using the method explained above, the optimum delay value must be between φ0 and φ1. Therefore, it is necessary to appropriately set initial values for φ0 and φ1.

In regards to this, as a result of the inventors of the present invention performing subjective testing, it was clear that the optimum delay value exists within the range between π radians and 2π regardless of the characteristics of the listener or the listening environment (for example, see FIG. 2). This conclusion can be arrived at from physical investigation as well.

In other words, this surround playback system creates a sound pressure dip (area where the sound pressure particularly drops in comparison with other positions) at the position of the ear on one side of the listener by mutual interference of sound waves that are outputted from the left and right, and in doing so, enhances the difference between the sound pressure level between both ears of the listener.

Moreover, the case of no difference between the left and right sound pressure will be explained, however, by delaying the phase of the sound waves that are outputted from the left speaker, the sound pressure dip moves to the right. In this way, when the amount of delay becomes π radians, the sound waves that are outputted from the left and right speakers have a nearly reverse phase relationship on the perpendicular angle bisector for the line segment that connects the left and right speakers. When this occurs, presuming that the listener is positioned on this perpendicular angle bisector, the level of the sound pressure between both ears of the listener will be the same, and the localization angle of the sound image becomes 0°. In other words, the listener feels that the sound image is positioned directly in front. Therefore, in order to position the sound pressure dip near the right ear, it is necessary to delay the sound waves that are outputted from the left speaker even more than π radians.

In addition, when the delay amount becomes 2π radians, the state s the same as when there is no phase delay, so the localization angle in that case basically becomes 0°.

Therefore, in this embodiment, the initial value for φ0 is set to π radians and the initial value for φ1 is set to 2π radians. By doing so, subjective testing can be omitted in the range from 0 to π radians. Of course, the same is true even in the case where the initial value of φ0 is set to (2n−1)π radians, and the initial value of φ1 is set to 2nπ radians (n is a natural number 2 or greater), however, needless to say, in this range π and 2π radians are optimum.

As long as the range includes the optimum delay value, it does not really matter what values the initial values of φ0 and φ01 are set as.

### [3.2 Method for Determining the Optimum Delay Value at Other Frequencies]

FIGS. 4A, 4B, FIGS. 5A, 5B and FIGS. 6A, 6B are graphs illustrating the results of subjective testing by two testers when the frequencies of the test sound were 500 Hz, 250 Hz and 125 Hz, respectively. A small difference sound pressure was applied between the left and right test sounds, so the localization angle at 0 radians and 2π radians shifted a little from 0°.

In FIG. 4A, which illustrates the result for tester A when the frequency is 500 Hz, the delay value when the localization angle becomes a maximum is 1.3π radians. Moreover, in FIG. 4B, which similarly illustrates the result for tester B when the frequency is 500 Hz, the delay value when the localization angle becomes a maximum is 1.1π radians. Therefore, when the frequency is 500 Hz, the listeners see a difference in the optimum delay value.

On the other hand, in FIG. 5A, which illustrates the result for tester A when the frequency is 250 Hz, the delay value when the localization angle becomes a maximum is π radians, (actually, the optimum delay value is thought to exist between π radians and 1.1π radians). Moreover, similarly in FIG. 5B, which illustrates the result for tester B when the frequency is 250 Hz, the delay value when the localization angle is a maximum is π radians. Therefore, when the frequency is 250 Hz, the listeners see hardly any difference in the optimum delay value.

Furthermore, in FIG. 6A, which illustrates the result for tester A when the frequency is 125 Hz, the delay value when the localization angle is a maximum is π radians (actually, the optimum delay value is considered to be between π radians and 1.1π radians). Moreover, similarly in FIG. 6B, which illustrates the result for tester B when the frequency is 125 Hz, the delay value when the localization angle is a maximum is π radians. Therefore, when the frequency is 125 Hz, the listeners see hardly any difference in the optimum delay value.

As is clear from the results of this subjective testing, in the range of a comparatively low frequency band, the listener characteristics have little effect on the optimum delay value. Therefore, in this range, by finding the optimum delay value in advance, there is no need to perform a subjective test again when a user actually uses the surround playback system.

In addition, FIG. 7 illustrates the results found for the optimum delay values when subjective testing was performed for each ⅓ octave from 125 Hz to 2000 Hz. As illustrated in FIG. 7, this graph has a shape close to a curved line (elliptical arc shape). Therefore, by being able to find the optimum delay value at three frequencies, it is possible to find optimum delay values at other frequencies through curve interpolation.

Therefore, in this embodiment, an optimum delay value that is found in advance for one frequency band at an arbitrary frequency of 250 Hz or less is set, and subjective testing is performed for two frequency bands at arbitrary frequencies greater than 250 Hz to find the optimum delay values, then the optimum delay values for other frequency bands are found from these three optimum delay values using interpolation. In this way, the number of frequencies that need to become the object of subjective testing can be reduced.

Interpolation of the optimum delay values for other frequencies can also be found through interpolation using the optimum delay values for four or more frequency bands. Moreover, interpolation of the optimum delay values for other frequencies can also be found through interpolation of three or more optimum delay values that were obtained through subjective testing.

Furthermore, it is not necessary that the delay value setting device 10 be constructed so that both the method explained in section 3.1 and the method explained in section 3.2 above be executed. It is possible to reduce the number of times subjective testing is performed by even just one of the methods.

### [4. Operation of the Delay Value Setting Device]

Next, the operation of the delay value setting device 10 of this embodiment will be explained.

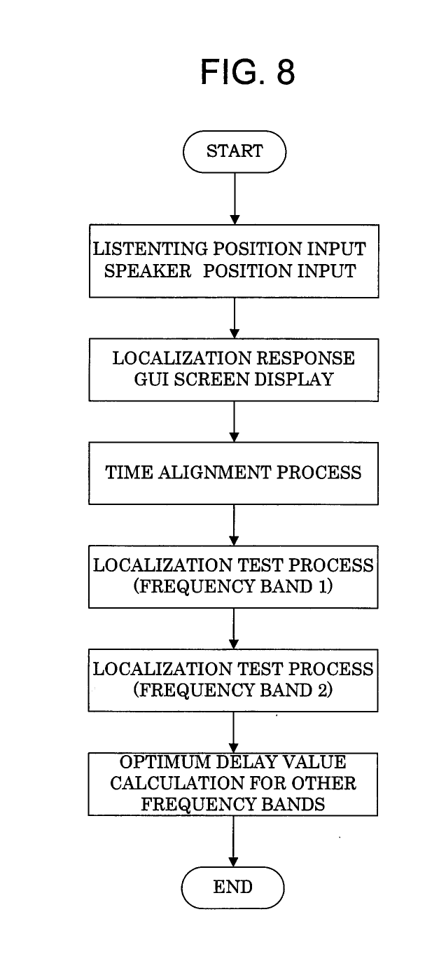

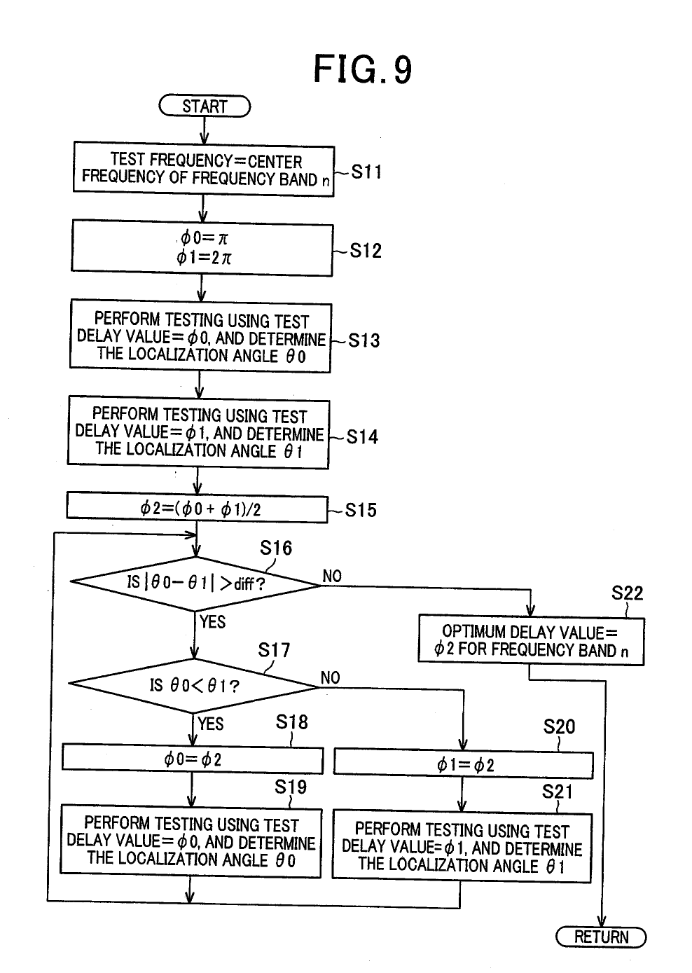

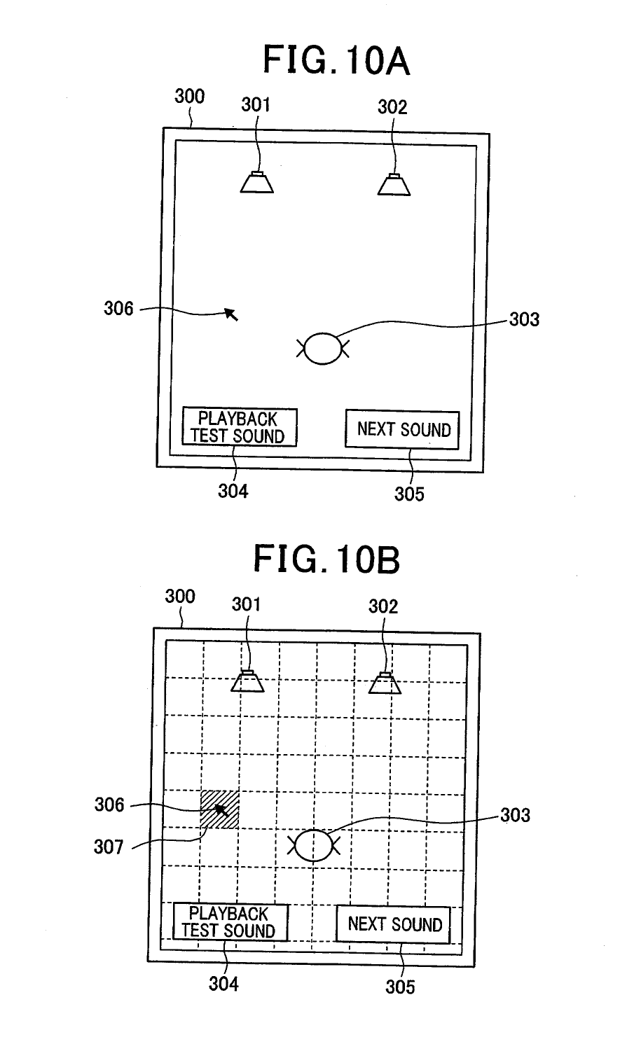

FIG. 8 is a flowchart illustrating the processing in the optimum delay value setting process by the delay value setting device 10 of this embodiment. FIG. 9 is a flowchart illustrating the processing in the localization testing process by the delay value setting device 10 of this embodiment. FIGS. 10A and 10B are diagrams illustrating an example of a GUI screen 300 for a localization response.

As illustrated in FIG. 8, when the user operates the input unit 16 and gives an instruction to start setting the delay value, the calculation unit 11 of the delay value setting device 10 causes a message to be displayed on the GUI display unit 15 and prompts the user to input the listening position and speaker position. The listening position is the distance from the center point between the left speaker LS and right speaker RSP to the user. The speaker position is the distance between the left speaker LSP and the right speaker RSP.

Here, when the user operates the input unit 16 and inputs the listening position and the speaker position (step S1), the calculation unit 11 causes the GUI screen 300 for the localization response to be displayed on the GUI display unit 15 (step S2).

As illustrated in FIG. 10A, the GUI screen 300 for the localization response comprises a left speaker mark 301, a right speaker mark 302, a user mark 303, a playback button 304, a next button 305 and the like.

The left speaker mark 301, right speaker mark 302 and user mark 303 represent the left speaker LSP, right speaker RSP and user, and the positional relationship is displayed according to the input listening position and speaker position. The user operates the input unit 16 and moves the pointer 306, and specifying an arbitrary position on the screen, the user specifies the location (or direction) of the test sound that the user feels.

The test playback button 304 is a button for the user to listen to the test sound again. The next button 305 is a button for listening to the next test sound (a test sound having a different delay value or a test sound having a different frequency from the current test sound).

By providing the user with a graphical user interface in this way, the delay value setting device 10 makes it easy for the user to respond.

The GUI screen 300 for the localization response can also be displayed as illustrated in FIG. 10B, for example. FIG. 10B differs from FIG. 10A in that a grid is displayed in FIG. 10B, and as illustrated by reference number 307, an area of the areas divided by the grid where the pointer 306 is located is highlighted, for example. Here, the user can specify the location of the test sound by selecting an arbitrary area of the grid that is displayed on the screen. In the display illustrated in FIG. 10A, detailed setting is possible, however, in FIG. 10B it is possible to make it easier for the user to respond by limiting the selection range.

After displaying the GUI screen 300 for the localization response, the calculation unit 11 executes a time alignment process (step S3). More specifically, the calculation unit 11 sets a delay value so that the location of the sound image is directly in front of the user (so that the localization angle becomes 0°) based on the inputted listening position and speaker position.

Next, the calculation unit 11 executes a localization test process (described later) for a preset frequency band 1 (for example, a center frequency of 500 Hz) (step S4), then executes the localization test process for a frequency band 2 (for example, a center frequency of 2000 Hz) (step S59. In this process, subjective testing is performed, and the optimum delay value is found for the two frequency bands.

As illustrated in FIG. 9, in the localization test process, the calculation unit 11, first, sets the center frequency of the frequency band that was set in the test signal generation unit 13 as the test frequency to be used in testing (step S11).

Next, the calculation unit 11, sets φ0 to π radians, and sets φ1 to 2π radians (step S12).

Next, the operation unit 11 sets φ0 as the test delay value, and performs the subjective test process using this test delay value, and determines θ0 for this test (step S13). More specifically, the calculation unit 11 sets the test delay value in the delay unit 14. Next, the calculation unit 11 controls the test signal generation unit 13 in order to generate a test signal at the set test frequency. The test signal that the test signal generation unit 13 generates is supplied as is to the left speaker LSP and is also supplied to the delay unit 14. In addition, the test signal that is delayed by the delay unit 14 using the set test delay value is supplied to the right speaker RSL. The test sound at the test frequency is then outputted from both the left speaker LS and right speaker RSP.

The user, who hears this test sound, operates the input unit 16 while watching the GUI screen 300 for the localization response that is displayed on the GUI display unit 15, and specifies the location of the test sound. Information that corresponds to the specified location is supplied to the calculation unit 11 from the input unit 16, and the calculation unit 11 calculates θ0 based on this information, the listening position and the speaker position.

After determining θ0 in this way, the calculation unit 11 similarly sets φ1 as the test delay value, performs the subjective test process using this test delay value, and determines θ1 for this test delay value (step S14).

Next, the calculation unit 11 calculates θ2=(θ0+θ1)/2 to calculate the value θ2 (step S15). In other words, the calculation unit 11 calculates the average value of θ0 and θ1.

Next, the calculation unit 11 determines whether or not the absolute value |θ0-θ1| is larger than a threshold value diff (an example of a threshold value) (step S16). In other words, the calculation unit 11 determines whether or not the absolute value of the difference between θ0 and θ1 is greater than a threshold value.

At this time, when it is determined that the absolute value |θ0-θ1| is greater than the threshold value diff (step S16: YES), the calculation unit 11 then determines whether θ0 is less than θ1 (step S17).

In this step, when θ0 is less than θ1 (step S17: YES), θ0 is set as θ2 (step S18), and this changed θ0 is set as the test delay value, then as in step S13, the subjective test process is performed for this test delay value, and after θ0 has been determined (step S9), processing advances to step S16.

On the other hand, when θ0 is not less than θ1 (step S17: NO), the calculation unit sets θ1 as θ2 (step S20), and sets this changed θ1 as the test delay value, then as in step S13, performs the subjective test process using this test delay value, and determines θ1 (step S21), then advances to step S16.

In this way, the calculation unit 11 performs subjective testing of the changed delay value while changing φ0 or φ1, and when the absolute value |θ0-θ1| becomes equal to or less than the threshold value diff (step S16: NO) sets φ2 as the optimum delay value for the set frequency band (step S1) and ends the localization test process.

After the calculation unit 11 ends the localization test process for two frequency bands, the calculation unit 11 then calculates the optimum delay values for the other frequency bands (step S6). More specifically, the calculation unit 11 acquires the optimum delay value for the specified low frequency band (for example, 125 Hz) from the memory unit, performs linear interpolation using this optimum delay value and the two optimum delay values that were determined through subjective testing, and in this way calculates the optimum delay values for the other frequency bands. In addition, the calculation unit 11 stores the optimum delay values determined through the subjective testing process and the interpolated optimum delay values in the memory unit 12 as delay values to be used in the surround playback system.

As explained above, with this embodiment, the test signal generation unit 13 generates a test signal, and together with supplying that test signal to the left speaker LSP, supplies the test signal to the delay unit 14. The delay unit 14 delays this test signal according to the test delay value that was set by the calculation unit 11, and supplies that delayed test signal to the right speaker RSP. The test sound is outputted from the speakers LSP and RSP and the user specifies the localization direction of the sound image using the input unit 16, after which, the calculation unit 11 finds the localization angle that corresponds to that localization direction. After finding the localization angles θ0 and θ1 using two different delay values φ0 and φ1 in this way, the calculation unit 11 compares the difference between the two localization angles with the threshold value diff. While determining whether the difference is greater than the threshold value diff, the calculation unit 11 changes one of φ0 and φ1 and finds the localization angle that corresponds to the changed delay value, then again compares the difference between the two localization angles with the threshold value diff. When it is determined that the difference is equal to or less than the threshold value diff, the calculation unit 11 selects a delay value within the range from φ0 to φ1 as the optimum delay value.

Therefore, the optimum delay values can be found in addition to being able to reduce the number of delay values for which subjective testing must be performed, so the burden on the user due to testing is reduced, and optimum delay values can be set efficiently.

Moreover, the initial values are set so that the delay value where the localization angle is a maximum is within the range from the initial value for φ0 to the initial value for φ1, so the optimum delay value can be found more efficiently. Particularly, the initial value for φ0 is π radians and the initial value for φ1 is 2 π radians, so the optimum delay value can be found within the optimum range.

Furthermore, while determining whether the difference between φ0 and φ1 is greater than the threshold value diff, the calculation unit 11 changes the test delay value having the smaller localization angle so that it is closer to the other test delay value. Particularly, the calculation unit 11 changes the test delay value having the smaller localization value to (φ0+φ1)/2, so the number of times subjective testing is performed can be reduced efficiently.

When the calculation unit 11 determine that the difference between φ0 and φ1 is equal to or less than the threshold diff, the optimum delay value is taken to be (φ0+φ1)/2, so the optimum delay value can be found more efficiently.

Moreover, according to control from the calculation unit 11, the test signal generation unit 13 generates a test signal at different timing for a plurality of frequencies that are different from each other, and the calculation unit 11 determines the optimum delay values for each of the frequency bands taking these frequencies to be the center frequencies, and calculates the optimum delay for the other frequency bands based on this plurality of optimum delay values.

Therefore, optimum delay values can be found in addition to reducing the number of frequency bands for with subjective testing must be performed, so the burden on the user due to testing is reduced, and the optimum delay values can be set efficiently.

Moreover, the calculation unit 11 finds the optimum delay values for other frequency bands through linear interpolation using the two optimum delay values found through subjective testing for the two frequency bands and the preset optimum delay value for the predetermined frequency band, so the optimum delay values can be found for all of the necessary frequency bands by performing subjective testing for just two frequency bands. Particularly, the predetermined frequency band is selected in a range (250 Hz or less) that is little affected by the listener characteristics, and the optimum delay value that is obtained for that frequency by subjective testing is preset, so the optimum delay values for other frequency bands can be calculated with good precision.

[5. Example of Application to a Surround Playback System (4.1ch)]

Next, an example of applying the embodiment above to the AV amp of a 4.1ch surround playback system is explained.

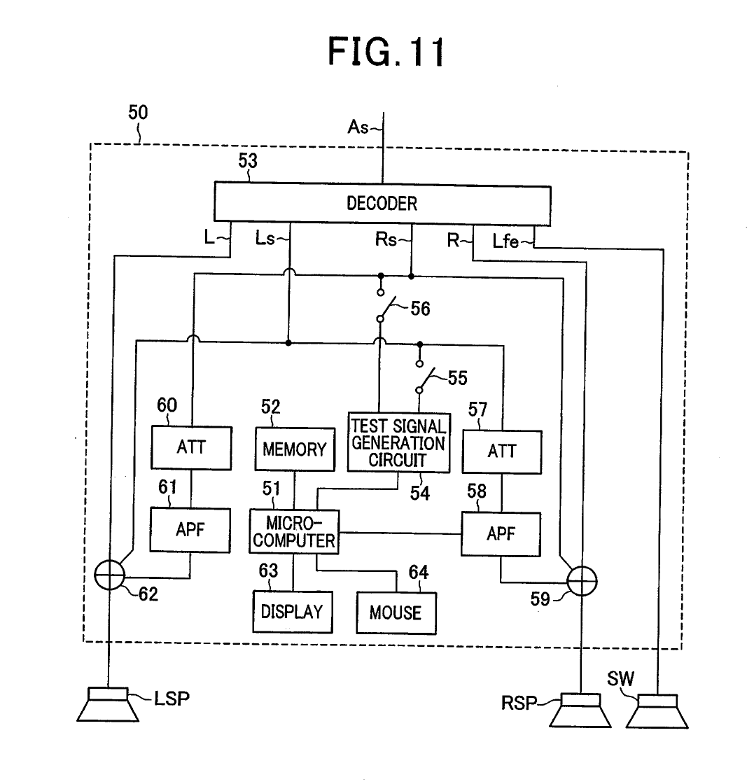

FIG. 11 is a block diagram illustrating an example of the construction of an AV amp 50 of this embodiment.

As illustrated in FIG. 11, the AV amp 50 comprises: a microcomputer 51, memory 52, decoder 53, test signal generation circuit 54, switches 55 and 56, attenuators 57 and 60, all-pass filters 58 and 61, adders 59 and 62, display 63 and mouse 64.

Here, the microcomputer 51 functions as a comparison unit, control unit selection unit, calculation unit and setting unit; the test signal generation circuit 54 functions as a test sound signal output unit. In addition, the all-pass filters 58 and 61 function as a delay unit, the adders 59 and 62 function as one output unit and another output unit, and the mouse 64 functions as an input unit.

The microcomputer 51 comprises a CPU, ROM, RAM and the like, and by reading and executing various programs that are stored in memory 52, controls the AV amp 50 as well as functions as a comparison unit, control unit selection unit, calculation unit and setting unit.

The memory 52 is a flash memory and stores various programs and optimum delay values.

An audio stream signal As is input to the decoder 53 from outside the AV amp 50, and that decoder 53 decodes this audio stream signal As and outputs a left-side stereo signal L, right-side stereo signal R, left-side surround signal Ls, right-side surround signal Rs and low sound frequency effect signal Lfe.

The left-side stereo signal L that is outputted from the decoder 53 is supplied to the adder 62. The right-side stereo signal R is supplied to the adder 59.

Moreover, the left-side surround signal Ls is supplied to the adder 62 and attenuator 67. The right-side surround signal Rs is supplied to the adder 59 and attenuator 60. In addition, the low sound frequency effect signal Lfe is supplied to a subwoofer SW.

The test signal generation circuit 54 supplies a test signal having a frequency that was set by the microcomputer 51 to the switches 55 and 56.

One terminal of switch 55 is connected to the test signal generation circuit 54, and the other terminal is connected to the adder 62 and attenuator 57. When the switch 55 is switched ON, the test signal from the test signal generation circuit 54 is supplied to the adder 62 and attenuator 57.

The attenuator 57 attenuates (for example, 6 dB) the left-side surround signal Ls that is supplied from the decoder 53, or the test signal that is supplied from the test signal generation circuit 54, and supplies the result to the all-pass filter 58.

The all-pass filter 58 delays the output signal from the attenuator 57 for each frequency band. More specifically, the all-pass filter 58 divides the output signal that covers five octaves from around 125 Hz to around 4 KHz into frequency bands every ⅓ octave, delays the signal by the delay value that is set by the microcomputer 51 for each frequency band division, and combines the signals from each of the delayed frequency bands into one signal. The all-pass filter 58 supplies the combined signal to the adder 59.

The adder 59 adds the right-side stereo signal R from the decoder 53, the right-side surround signal Rs also from the decoder 53, and the output signal from the all-pass filter 58, and outputs the added signal to the right-side speaker RSP.

One terminal of switch 56 is connected to the test signal generator circuit 54, and the other terminal is connected to the adder 59 and attenuator 60. When switch 56 is switched ON, a test signal is supplied to the adder 59 and attenuator 60 from the test signal generator circuit 54.

The attenuator 60 attenuates (for example 6 dB) the right-side surround signal Rs that is supplied from the decoder 53 or the test signal that is supplied from the test signal generation circuit 54, and supplies the result to the all-pass filter 61.

The all-pass filter 61 delays the output signal from the attenuator 60 and supplies the result to the adder 59. The construction of the all-pass filter 61 is the same as the all-pass filter 58.

The adder 62 adds the right-side stereo signal from the decoder 53, the left-side stereo signal that is similarly from the decoder 53 and the output signal from the all-pass filter 61, then outputs the added signal to the left-side speaker LSP.

The operation of the AV amp 50 is explained below.

First, based on control from the microcomputer 51, the optimum delay values that are used in the all-pass filters 58 and 61 are set. More specifically, processing is basically the same as the processing illustrated in FIG. 8 and FIG. 9.

Here, when performing setting of the all-pass filter 58, the microcomputer 51 first turns switch 55 ON and turns switch 56 OFF. In doing so the test signal that is outputted from the test signal generation circuit 54 is supplied to the left speaker LSP via the adder 62, and a test sound is outputted from that left speaker LSP. Similarly, a test signal that is output from the test signal generation unit 54 is attenuated by the attenuator 57 and further delayed by the all-pass filter 58. In addition, that test signal is supplied to the right speaker RSP via the adder 59, and a delayed test sound is output from the right speaker RSP. Moreover, for two frequency bands, the microcomputer 51 appropriately changes φ0 and φ1 ands sets them in the all-pass filter, and finds the optimum delay value for each frequency band from the optimum delay values obtained as a result, then stores those values in the memory 52.

Moreover, when setting the all-pass filter 61, the microcomputer 51 first turns the switch 55 OFF and turns the switch 56 ON. In doing so, a test signal that is outputted from the test signal generation circuit 54 is supplied to the right speaker RSP via the adder 59, and a test sound is outputted from that right speaker RSP. Similarly, the test signal that is outputted from the test signal generation circuit 54 is attenuated by the attenuator 60, and is further delayed by the all-pass filter 61. In addition, this test signal is supplied to the left speaker LSP via the adder 62, and a delayed test sound is outputted from that left speaker LSP. Moreover, the microcomputer 51 finds the optimum delay values as in the case of the all-pass filter 58, and stores those values in the memory 52.

After the optimum delay values have been set, when the user gives an instruction for audio playback, the microcomputer 51 switches OFF both switches 55 and 56 so that the output signal from the decoder 53 is supplied to all units. The microcomputer 51 also sets the optimum delay values for each frequency band that are stored in the memory 52 in the all-pass filters 58 to 61. In addition, when the audio stream signal As is inputted to the decoder 53, the decoder 53 decodes that signal, and outputs a left-side stereo signal L, right-side stereo signal R, left-side surround signal Ls, right-side surround signal Rs and low sound frequency effect signal Lfe. After the left-side surround signal Ls has been supplied to the attenuator 57, that signal is delayed by the attenuator 57 and attenuated by the all-pass filter 58. Moreover, after the right-side surround signal Rs has been supplied to the attenuator 60, that signal is delayed by the attenuator 60 and attenuated by the all-pass filter 61.

The adder 62 adds the left-side stereo signal L, left-side surround signal Ls and the output signal from the all-pass filter 61, and supplies the result to the left speaker LSP. In addition, the adder 59 adds the right-side stereo signal R, right-side surround signal Rs and the output signal from the all-pass filter 58, and supplies the result to the right speaker RSP.

By using the AV amp 50 having the construction and operation described above, users are able to enjoy surround sound suitable to their own listening environment.

This embodiment is not limited to a 4.1ch surround playback system, but can also be applied to other systems such as a 5.1ch or 4ch surround playback system

Moreover, the present invention is not limited to the embodiment above. The embodiment described above is an example, and anything that essentially has similar construction and functional effect within the technical scope as disclosed in the claims of the present invention is included within the technical range of present invention.

1. A delay amount determination device, comprising:
a test sound signal output unit that outputs a test sound signal;
a delay unit that delays the test sound signal according to the set delay amount;
an input unit for inputting the localization direction of the sound image felt by the listener when a test sound that corresponds to the test sound signal is outputted from one speaker, and when a test sound that corresponds to the test sound signal that was delayed by the delay unit is outputted from another speaker;
a comparison unit that compares the difference between one localization angle and another localization angle with a threshold value, wherein the localization angles correspond with localization directions that were inputted using the input unit when the test sound signal is delayed by two different delay amounts;
a control unit that changes one of the two delay amounts while determining whether the difference is greater than the threshold value, and causes the comparison unit to perform the comparison using the one localization angle and the other localization angle when the test sound signal is delayed by the changed delay amount; and
a selection unit that selects one delay amount within a range from one of the two delay amounts to the other delay amount based on a predetermined condition when the difference is determined to be less than the threshold value.

2. The delay amount determination device according to claim 1, wherein
the initial values of the two delay amounts are set so that the delay amount for which the localization angle becomes a maximum is included within the range from one of the two delay amounts to the other delay amount.

3. The delay amount determination device according to claim 2, wherein
the initial value of one of the two delay amounts is set to π radians, and the initial value of the other delay amount is set to 2π radians.

4. The delay amount determination device according to claim 1, wherein
the control unit changes the delay amount of the two delay amounts for which the localization amount is smaller to an amount that is closer to the other delay amount.

5. The delay amount determination device according to claim 4, wherein
the control unit changes the delay amount of the two delay amounts for which the localization amount is smaller to the average value of the two delay amounts.

6. The delay amount determination device according to claim 1, wherein
the selection unit selects the average value of the two delay amounts.

7. The delay amount determination device according to claim 1, wherein
the test sound signal output unit generates the test sound signals for a plurality of different frequencies;
the selection unit selects a delay amount for each frequency; and
further comprises a calculation unit that, except for the plurality of frequencies, calculates delay amounts for other frequencies based on the delay amounts selected for each frequency by the selection unit.

8. The delay amount determination device according to claim 7, wherein
the test sound signal output unit generates the test sound signals for two frequencies; and
the calculation unit interpolates the delay amounts for the other frequencies based on the delay amount set in advance for a predetermined frequency, and two the delay amounts that were selected by the selection unit.

9. The delay amount determination device according to claim 8, wherein
the predetermined frequency is set within a predetermined range as a frequency range where the difference between listeners or listening environments in the localization direction that is felt by the listener to be the optimum direction is small; and
the two frequencies are set outside of the predetermined range.

10. A sound image localization device, comprising:
a delay amount determination device, comprising:
a test sound signal output unit that outputs a test sound signal;
a delay unit that delays the test sound signal according to the set delay amount;
an input unit for inputting the localization direction of the sound image felt by the listener when a test sound that corresponds to the test sound signal is outputted from one speaker, and when a test sound that corresponds to the test sound signal that was delayed by the delay unit is outputted from another speaker;
a comparison unit that compares the difference between one localization angle and another localization angle with a threshold value, wherein the localization angles correspond with localization directions that were inputted using the input unit when the test sound signal is delayed by two different delay amounts;
a control unit that changes one of the two delay amounts while determining whether the difference is greater than the threshold value, and causes the comparison unit to perform the comparison using the one localization angle and the other localization angle when the test sound signal is delayed by the changed delay amount; and
a selection unit that selects one delay amount within a range from one of the two delay amounts to the other delay amount based on a predetermined condition when the difference is determined to be less than the threshold value, wherein the selection unit selects the average value of the two delay amount;
a setting unit that sets the delay amount selected by the selection unit as the delay amount to be used by the delay unit;
one output unit that outputs the inputted sound signal to one of the speakers; and
another output unit that outputs the sound signal that was delayed by the delay unit to the other speaker; wherein
the delay unit delays the sound signal.

11. A sound image localization device, comprising:
a delay amount determination device, comprising:
a test sound signal output unit that outputs a test sound signal;
a delay unit that delays the test sound signal according to the set delay amount;
an input unit for inputting the localization direction of the sound image felt by the listener when a test sound that corresponds to the test sound signal is outputted from one speaker, and when a test sound that corresponds to the test sound signal that was delayed by the delay unit is outputted from another speaker;
a comparison unit that compares the difference between one localization angle and another localization angle with a threshold value, wherein the localization angles correspond with localization directions that were inputted using the input unit when the test sound signal is delayed by two different delay amounts;
a control unit that changes one of the two delay amounts while determining whether the difference is greater than the threshold value, and causes the comparison unit to perform the comparison using the one localization angle and the other localization angle when the test sound signal is delayed by the changed delay amount; and
a selection unit that selects one delay amount within a range from one of the two delay amounts to the other delay amount based on a predetermined condition when the difference is determined to be less than the threshold value, wherein:
the test sound signal output unit generates the test sound signals for a plurality of different frequencies;
the selection unit selects a delay amount for each frequency; and
further comprises a calculation unit that, except for the plurality of frequencies, calculates delay amounts for other frequencies based on the delay amounts selected for each frequency by the selection unit;
a setting unit that sets the delay amount selected by the selection unit and the delay amount calculated by the calculation units as delay amounts to be used by the delay unit for the corresponding frequencies;
one output unit that outputs the inputted sound signal to one of the speakers; and
another output unit that outputs the sound signal that was delayed by the delay unit to the other speaker; wherein
the delay unit delays the sound signal for each frequency.

12. A delay amount determination method, comprising steps of:
outputting a test sound signal;
delaying the test sound signal according to the set delay amount;
comparing the difference between one localization angle and another localization angle with a threshold value, wherein the localization angles correspond with localization directions that were inputted using an input unit for inputting the localization direction of the sound image felt by the listener when a test sound that corresponds to the test sound signal is outputted from one speaker, and a test sound that corresponds to the test sound signal that was delayed is output from another speaker, when the test sound signal is delayed by two different delay amounts;
changing one of the two delay amounts while determining whether the difference is greater than the threshold value, and performing the comparison using the one localization angle and the other localization angle when the test sound signal is delayed by the changed delay amount; and
selecting one delay amount within a range from one of the two delay amounts to the other delay amount based on a predetermined condition when the difference is determined to be less than the threshold value.

13. A delay amount determination processing program that causes a computer to function as:
a test sound signal output unit that outputs a test sound signal;
a delay unit that delays the test sound signal according to the set delay amount;
an input unit for inputting the localization direction of the sound image felt by the listener when a test sound that corresponds to the test sound signal is outputted from one speaker, and a test sound that corresponds to the test sound signal that was delayed by the delay unit is outputted from another speaker;
a comparison unit that compares the difference between one localization angle and another localization angle with a threshold value, wherein the localization angles correspond with localization directions that were inputted using the input unit when the test sound signal is delayed by two different delay amounts;
a control unit that changes one of the two delay amounts while determining whether the difference is greater than the threshold value, and causes the comparison unit to perform the comparison using the one localization angle and the other localization angle when the test sound signal is delayed by the changed delay amount; and
a selection unit that selects one delay amount within a range from one of the two delay amounts to the other delay amount based on a predetermined condition when the difference is determined to be less than the threshold value.
